(19) United States
(12) Patent Application Publication
(10) Pub. No.: US 2005/0138340 A1
(43) Pub. Date: Jun. 23, 2005

(54) Method and apparatus to reduce spill and fill overhead in a processor with a register backing store

(75) Inventors: Yong-Fong Lee, San Jose, CA (US); Partha P. Kundu, San Jose, CA (US); Edward T. Grochowski, San Jose, CA (US)

Correspondence Address: Dennis A. Nicholls;BLAKELY, SOKOLOFF, TAYLOR & ZAFMAN LLP, Seventh Floor, 12400 Wilshire Boulevard, Los Angeles, CA, 90025-1030, US

(73) Assignee: Intel Corporation

(21) Appl. No.: 10/744,186

(22) Filed: Dec. 22, 2003

(51) Int. Cl. G06F 9/00

(52) U.S. Cl. 712/228

(57) ABSTRACT

A method and apparatus for selectively storing a register stack onto a register stack backing store is disclosed. In one embodiment, a non-exclusive boundary is determined enclosing registers that were actually used (e.g. written to) by a function. The description of that boundary is saved, and only the contents of the registers within the boundary are saved to register stack backing store as part of a spill operation. When the function is later restored, the description of the boundary is recalled and used to support the loading of just those registers from the register stack backing store as part of a fill operation.

### FIELD

The present disclosure relates generally to microprocessors, and more specifically to microprocessors capable of saving the contents of a register stack to memory.

### BACKGROUND

Modern microprocessors may support the frequent switching of execution from one portion of software to another. These portions of software may be called in various embodiments tasks, modules, subroutines, or functions. For the present disclosure the term “functions” will be used, with the understanding that the other terms tasks, modules, or subroutines may also be comprehended by the term functions. When a second function replaces a first function as the function currently executing, the state of the registers for the first function needs to be saved in order to support the eventual return of the first function to the status of currently executing function. The state of the registers may be saved by writing the contents of the registers to a backing storage area in memory. This process may be called “spilling”. The state of the registers may be restored by loading the registers with the contents of the backing storage area in memory. This process may be called “filling”.

For some processor architectures, the process of spilling may include saving the contents of all registers to the backing storage area. For other processor architectures, generally those with a large number of registers, a number of registers may be allocated by software to a given function. In these cases the process of spilling may include saving the contents of the allocated registers to the backing storage area. Either case may require a substantial amount of data transfer activity to memory both in the spilling process and in the subsequent filling process. This data transfer activity may directly affect system performance. However, the data transfer activity may also increase cache pollution, which may include the eviction of data that may be needed in the near future. The performance impact of cache pollution may be greater than that of the simple increase in data transfer activity to and from memory. In a multiple-process or multithreaded environment, cache lines holding spilled register's values tend to be displaced after context switches. When a process or thread is context switched back for further execution, the filling of saved register values will be more costly as a result.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic diagram showing a processor supporting storing a register stack in register stack backing store, according to one embodiment.

FIG. 2 is a diagram showing selective storing of a register stack in register stack backing store, according to one embodiment.

FIG. 3 is a schematic diagram showing a processor utilizing a register stack engine to store registers in a register stack backing store, according to an embodiment of the present disclosure.

FIGS. 4A and 4B are diagrams showing storing of registers on a per-function basis by a register stack engine, according to an embodiment of the present disclosure.

FIGS. 5A and 5B are diagrams showing a greatest register seen field, according to an embodiment of the present disclosure.

FIGS. 6A and 6B are diagrams showing selective storing of registers up to a greatest register seen value, according to an embodiment of the present disclosure.

FIGS. 7A and 7B are diagrams showing rMask bits, according to an embodiment of the present disclosure.

FIGS. 8A and 8B are diagrams showing storing of selected sets of registers identified by the rMask bits, according to an embodiment of the present disclosure.

FIG. 9 is a schematic diagram showing circuit elements to produce and use a register mask during register spill, according to an embodiment of the present disclosure.

FIG. 10 is a schematic diagram showing circuit elements to recall and use a register mask during register fill, according to an embodiment of the present disclosure.

FIGS. 11A and 11B are schematic diagrams showing systems including a processor supporting selective storing of registers in a register stack backing store, according to two embodiments of the present disclosure.

### DETAILED DESCRIPTION

The following description describes techniques for a selective spill and fill process to support the changing from one function to another function during the execution of software. In the following description, numerous specific details such as logic implementations, software module allocation, bus signaling techniques, and details of operation are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation. In certain embodiments the invention is disclosed in the form of an Itanium™ Processor Family (IPF) compatible processor or in a Pentium® family compatible processor such as those produced by Intel® Corporation. However, the invention may be practiced in other kinds of processors that may wish to use selective spill and fill of register contents. Certain additional details, such as the storing of the not-a-thing (NaT) bits into register stack backing store, have not been discussed in order not to obscure the invention of the present disclosure.

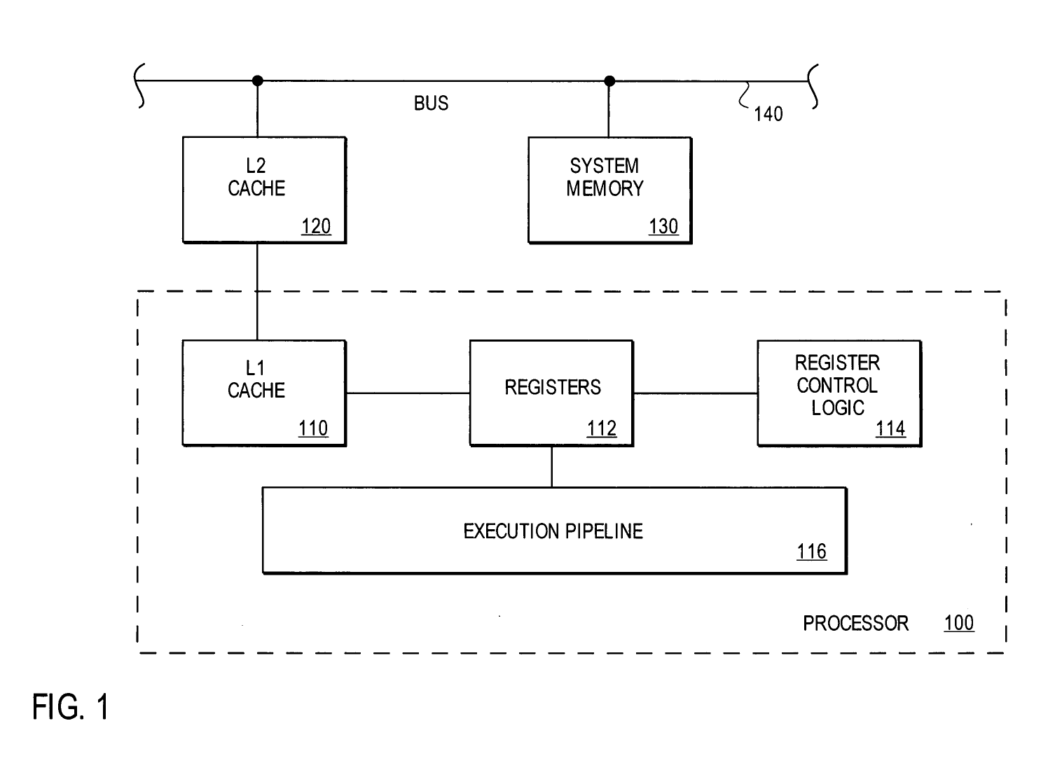

Referring now to FIG. 1, a schematic diagram of a processor 100 supporting storing a register stack in register stack backing store is shown, according to one embodiment. The registers 112 may be used as source or destination registers for the execution pipeline 116 under the control of the register control logic 114 circuitry. When a first function is replaced as the current function by a second function, such as occurs when the first function calls the second function, the register control logic 114 may initiate spilling: the storage of the contents of some or all of the registers 112 into memory. In one embodiment, the register control logic 114 may determine a subset of registers from the set of registers 112 which were actually read from or written to by commands within the first function prior to calling the second function. Then register control logic 114 may store the contents of the subset of registers into a portion of memory allocated as a register stack backing store, along with recording any information required to restore the registers for subsequent use by the first function.

The contents of the subset of registers spilled to the register stack backing store must first be stored in the innermost level-one (L1) cache 110. It is possible (but unlikely) that these contents could stay resident in L1 cache 110 until such time when the first function becomes current again. Generally the L1 cache 110 will writeback the contents of the subset of the registers spilled to a higher level-two (L2) cache 120, either through victimization of the cache lines or by a writeback operation initiated by cache coherency control logic. (Note that the writeback will proceed on a cache line by cache line basis.) Similarly the L2 cache 120 may writeback the contents of the subset of the registers spilled to system memory 130. Cache pollution in L1 cache 110 and L2 cache 120 may occur when the contents of the subset of the registers spilled are written to cache, during the writeback operations, and also during the subsequent fill operations to restore the contents of the register stack backing store to the registers for future use by the first function.

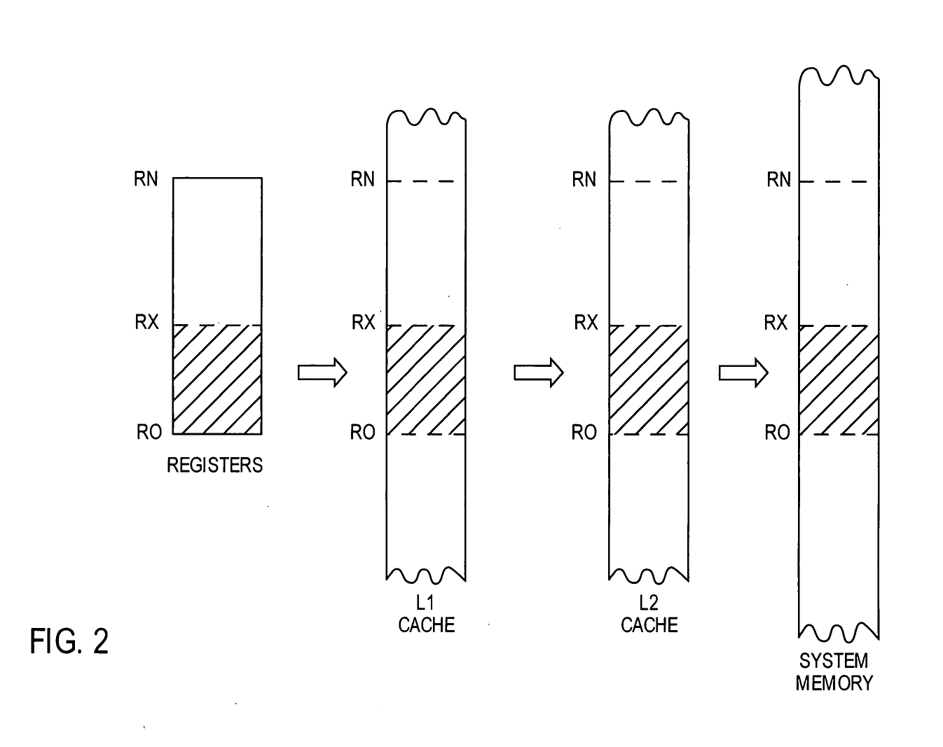

Referring now to FIG. 2, a diagram of selective storing of a register stack in register stack backing store is shown, according to one embodiment. In the FIG. 2 embodiment, there are N+1 registers labeled R0 through RN which may be allocated to a particular first function. The allocation may be performed by software instruction or by hardware in the architecture. Once the allocation is performed, the allocation is constant during a particular instantiation of the first function. In previous architectures, when the first function calls a new second function, the first function has all of its allocated registers saved into memory for future use upon the first function's return. However, in one embodiment the register control logic may track which of the registers are actually used (e.g. written to) by the first function prior to calling a second function. The register control logic may use this information to create a non-exclusive boundary around all the registers found to be used. Here “non-exclusive” means that the subset of registers within the boundary may also include some registers that were not used. In the FIG. 2 example, the register control logic has determined that a simple boundary could be the register RX, where the registers used may be described as registers R0 through RX, non-exclusively. It is noteworthy that the actual allocation of registers R0 through RN, whether by software or hardware, is not changed.

When the first function calls the second function, rather than saving all the registers R0 through RN, the register control logic may instead save only registers R0 through RX to a register stack backing store in memory. Such a spill operation would commence with saving the contents of R0 through RX into the L1 cache. Due to cache line evictions and cache coherency transfers, on a cache line by cache line basis the contents of R0 through RX may be written back to L2 cache and thence to system memory. During a subsequent fill operation, the register control logic will examine the boundaries constructed earlier, and initiate loads into the registers within the boundaries. In this manner the registers may be restored for the first function when the second function returns to it. The loads used for filling registers may or may not achieve cache hits in L1 cache or L2 cache depending upon how far the individual cache lines have been written back in the memory hierarchy. Here it is noteworthy that only a subset of the registers allocated to the first function need to be spilled and subsequently filled to support the restoration of the first function, and that the allocation of registers to the first function does not change.

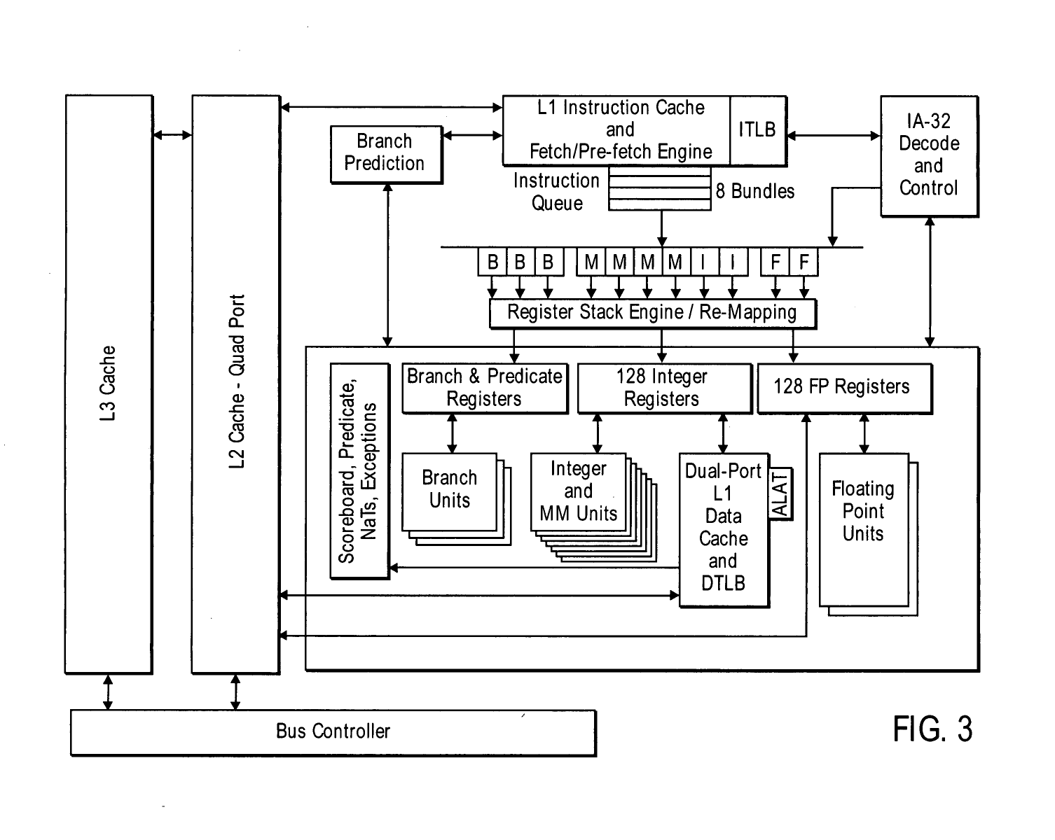

Referring now to FIG. 3, a schematic diagram of a processor utilizing a register stack engine to store registers in a register stack backing store is shown, according to an embodiment of the present disclosure. The memory hierarchy of the FIG. 3 processor includes L1 data and instruction caches, unified L2 and L3 caches, and system memory (not shown) on a bus connected via a bus controller. The FIG. 3 processor includes a relatively large number of integer registers (also called general registers) labeled Gr0 through Gr127. Because each function may or may not need to use all 128 registers, in one embodiment general registers in the range from Gr32 to Gr127 may be allocated to each function on an as-designed basis. In one embodiment an “alloc” allocation instruction may be used to convey this allocation to the processor. The allocation may be performed by a register stack engine (RSE), which may include a register re-mapping function. In cases where several functions do not need the entire range of available registers, there may be times when several functions may have their registers resident simultaneously. This may eliminate the need for spilling and filling altogether. And in those cases when spilling and filling are required, only those registers allocated to the function need be written to register stack backing store.

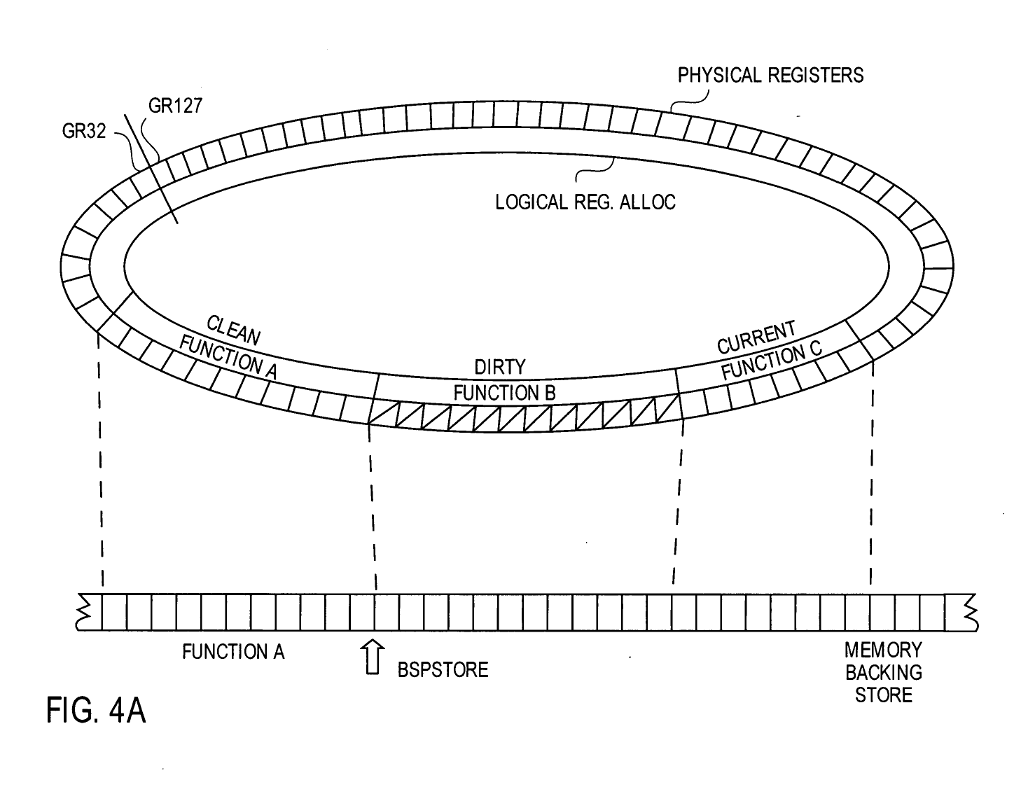

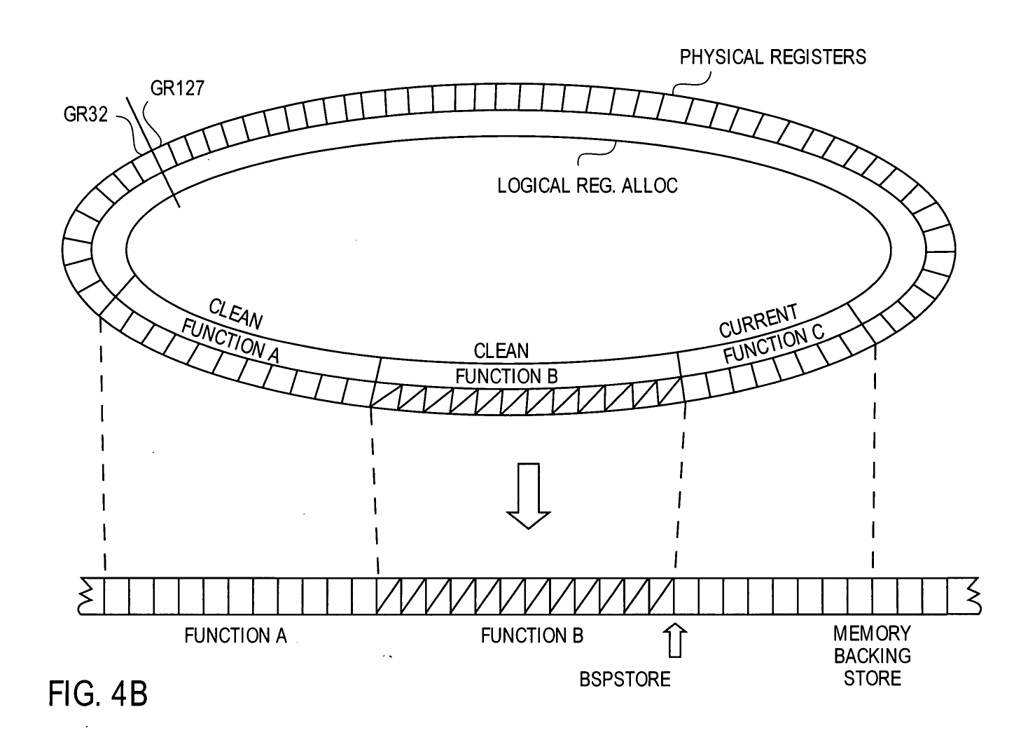

Referring now to FIGS. 4A and 4B, diagrams of the storing of registers on a per-function basis by a register stack engine are shown, according to an embodiment of the present disclosure. FIG. 4A generally shows the registers allocated to function B before spilling the register contents to memory backing store (also called register stack backing store), whereas FIG. 4B generally shows the registers allocated to function B after spilling with the allocated register contents in memory backing store. The physical registers in the range Gr32 through Gr127 are shown to be configured as a ring. Physical registers (shown on the outer ring) may be allocated to the logical registers required by one or more functions (shown on the inner ring). In one embodiment, the allocation may be performed by a software instruction inserted by a compiler, but in other embodiments the allocation may be performed by hardware. As one function calls another, the allocation of physical registers proceeds in a counter-clockwise direction around the ring. Once physical register Gr127 is allocated, physical registers starting over with Gr32 may be allocated to continue the process. FIGS. 4A and 4B show a unitary “memory” holding a memory backing store that may include differing levels of cache in addition to system memory. In these and subsequent figures, the memory addresses increase to the right hand side of the drawings. FIG. 4A shows the registers allocated to three functions, function A, function B, and function C, being resident simultaneously. Function C is currently being executed. Function A is flagged as being “clean” which means that the spilling for function A has completed and the physical registers allocated to function A may be re-allocated as necessary. Function B is flagged as being “dirty” which means that function B is not currently being executed, but that its allocated registers (stack frame) have not yet been copied to the register stack backing store. If the RSE needs to free up additional registers, the contents of the registers allocated to function B may be spilled to memory. Here backing-store-pointer-store (BSPSTORE) may be a pointer to the address in memory to which the RSE will spill the next stack frame.

In FIG. 4B, the spilling of the stack frame for function B has occurred. The contents of the registers allocated to function B have been stored in memory, and the pointer BSPSTORE has been advanced. The dirty flag associated with function B has been replaced by a clean flag. BSPSTORE now points to the next address in memory to which the RSE would spill a subsequent stack frame (e.g. for function C). In the FIGS. 4A and 4B example, all of the registers allocated to function B are spilled to memory backing store, without any consideration of whether the individual registers were actually used during the most recent execution of function B.

Upon the return of function B at some time in the future, the contents of the allocated physical registers for function B may be filled from the memory backing store, and function B may be made the current function again. (For more details about the FIGS. 4A and 4B implementation of a register stack engine, see “IA-64 Register Stack Engine”, chapter 6 of the Intel® Itanium™ Architecture Software Developer's Manual, Vol. 2 (System Architecture), rev. 2.0, December 2001, available from Intel® Corporation). Other architectures may include different implementation details in their implementation of a register stack engine.

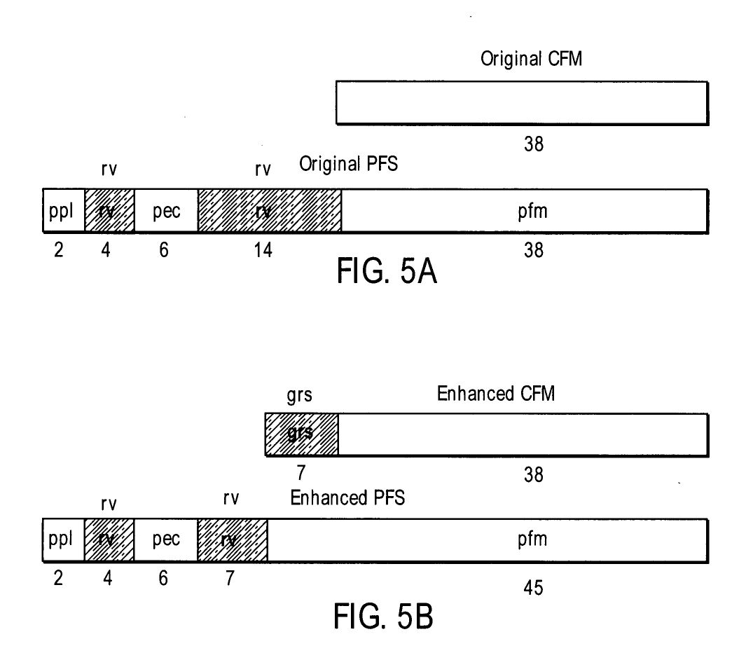

Referring now to FIGS. 5A and 5B, diagrams of a greatest register seen field are shown, according to an embodiment of the present disclosure. FIG. 5A shows a previous implementation of a current frame marker (CFM). Each function may have a frame marker associated with the allocated registers for that function (register stack frame). The CFM is the frame marker for the currently executing function. It may include fields such as a size of stack frame, size of local portion of stack frame, size of rotating portion of stack frame, and register rename base for general registers, floating-point registers, and predicate registers. When a new function is called, the previous values from CFM may be stored into a previous function state (PFS) register, which includes the previous frame marker (PFM) as a field.

There are sufficient reserved fields in the FIG. 5A PFS register that 7 reserved bits may be allocated to an enhanced PFM field, as is shown in FIG. 5B. In one embodiment, a non-exclusive boundary may be formed by the greatest register seen (grs) value, where grs is the number of the greatest physical register actually used by the current function during the current execution. Here “greatest” physical register actually used may mean the physical register in the greatest counter-clockwise position (as shown in FIGS. 4A and 4B) within those physical registers allocated to a function. (In those cases where registers adjacent to the boundary between physical registers Gr127 and Gr32 are allocated to the function, the “greatest” physical register may have a lower register number than “lesser” physical registers.) This grs value may change for each use of the function, as there may be many paths through the basic blocks of the function. The grs value may be constantly updated until the current function calls a new function. Then that grs value, along with the original CFM values, may be written into the enhanced PFM field of an enhanced PFS. When the previous function is returned at some future time, the grs value may be recovered and used to restore the registers of that function from the register stack backing store.

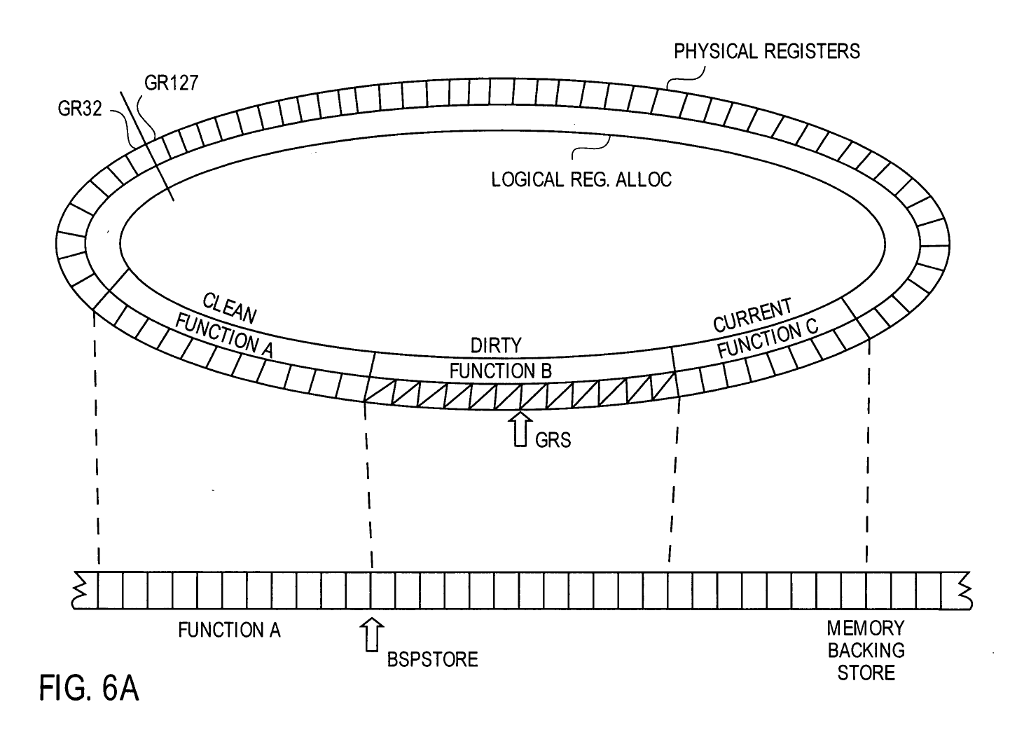

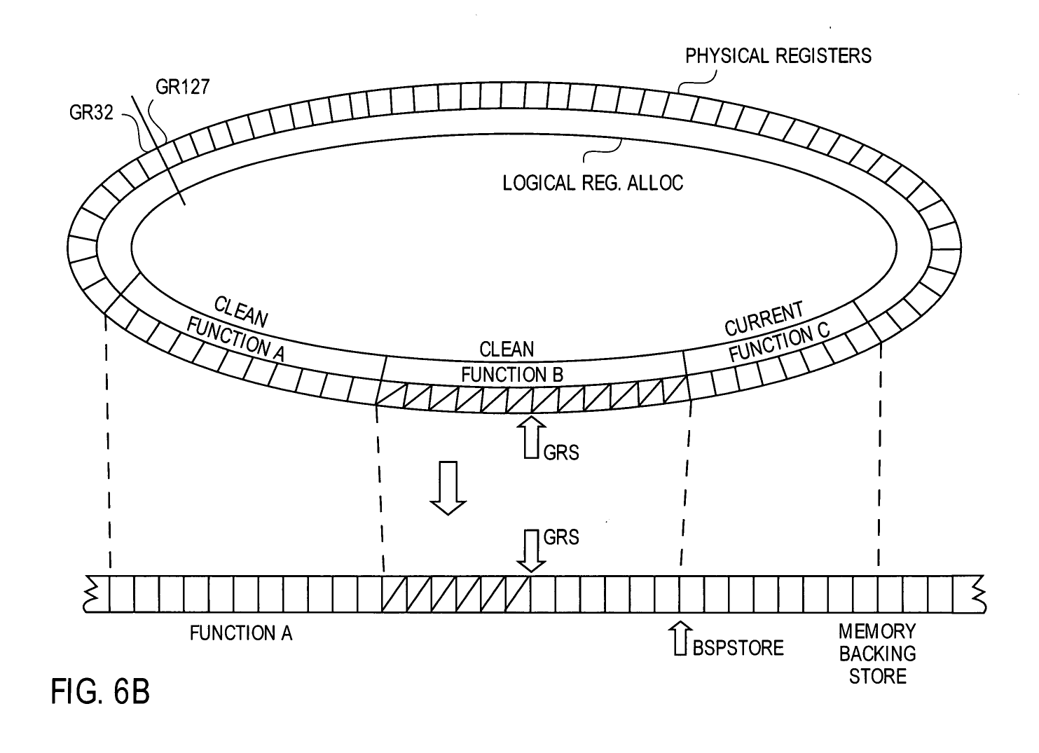

Referring now to FIGS. 6A and 6B, diagrams of the selective storing of registers up to a greatest register seen value are shown, according to an embodiment of the present disclosure. FIG. 6A generally shows the registers allocated to function B before spilling the register contents to memory backing store, whereas FIG. 6B generally shows the selected registers allocated to function B after spilling with the register contents in memory backing store. The allocation of registers to functions A, B, and C are generally as shown in FIGS. 4A and 4B above. A non-exclusive boundary of the registers actually used by function B during its previous execution may be created as shown by the grs value. Only the contents of the registers lying to the left of the GRS arrow need to be saved to memory backing store, because only those registers have been used. FIG. 6B shows the spilling of the selected registers within the non-exclusive boundary formed by the value in the grs register. The BSPSTORE pointer ends up in the same position as in the FIGS. 4A and 4B example. This is because the allocation of physical registers to function B has not changed, and the memory backing store may still be tailored to hold all physical registers that have been allocated to the function, regardless of whether they have been used. A subsequent fill operation would be able to recover the grs value and fill only the appropriate registers from the memory backing store, thus restoring the register stack for use by function B. In other embodiments, the architecture may require in certain circumstances that all of the allocated registers of function B be restored from the memory backing store regardless of whether the selective spilling as described above was previously performed. In these embodiments the filling may not be selective and any benefits may be limited to those supplied by the selective spilling as described above.

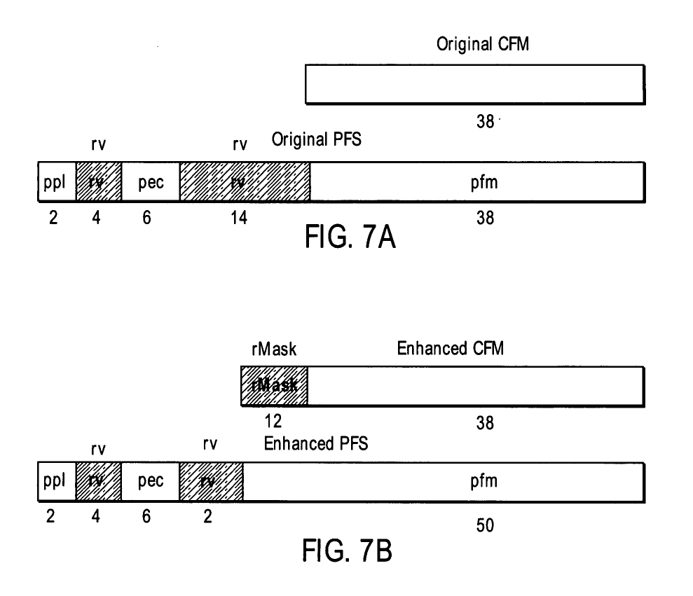

Referring now to FIGS. 7A and 7B, diagrams of rMask bits are shown, according to an embodiment of the present disclosure. The FIGS. 7A and 7B embodiment envisions dividing up all the registers available for allocation to functions into M equal, or substantially equal, subsets of registers. The non-exclusive boundary in this embodiment would include all the boundaries of the subsets wherein at least one register was used by the current function before it called a subsequent function. In one embodiment M=12, and the 96 general registers from Gr32 through Gr127 may be subdivided into 12 subsets of 8 registers each. The rMask field may include 12 bits, one bit for each subset, and each bit may be set whenever a register within the corresponding subset is used by the current function. In other embodiments, other numbers of subdivisions with differing numbers of registers each could be used, including subdivisions into subsets that need not be substantially equal in size. In the FIGS. 7A and 7B embodiment, the current rMask would be stored in an enhanced PFS as a portion of an enhanced PFM value. The rMask value could be recovered and used to restore the registers of that function from the register stack backing store.

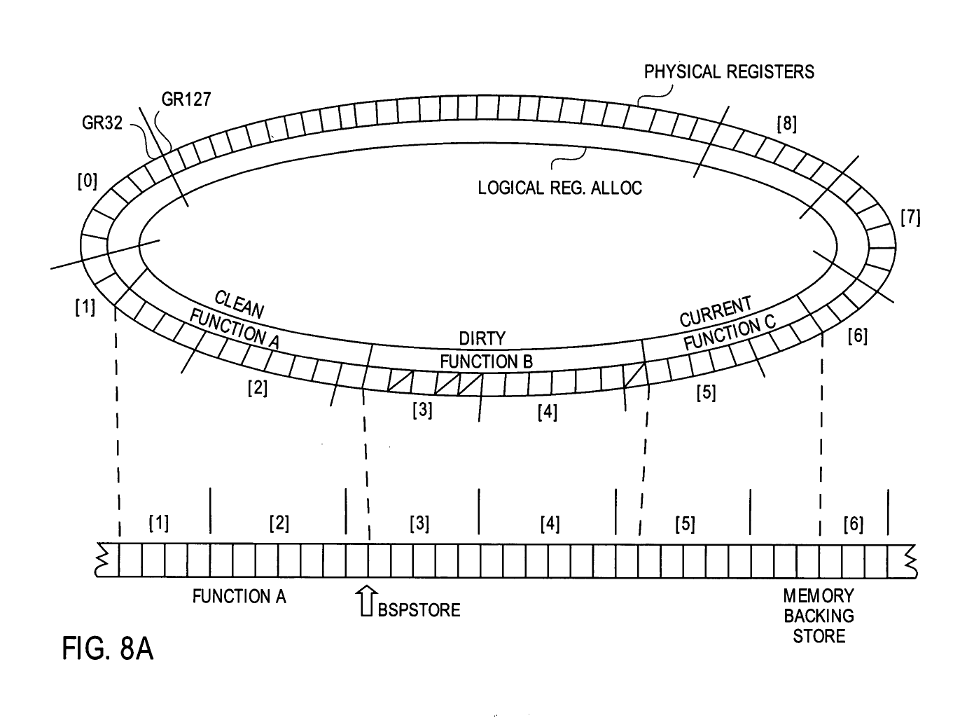

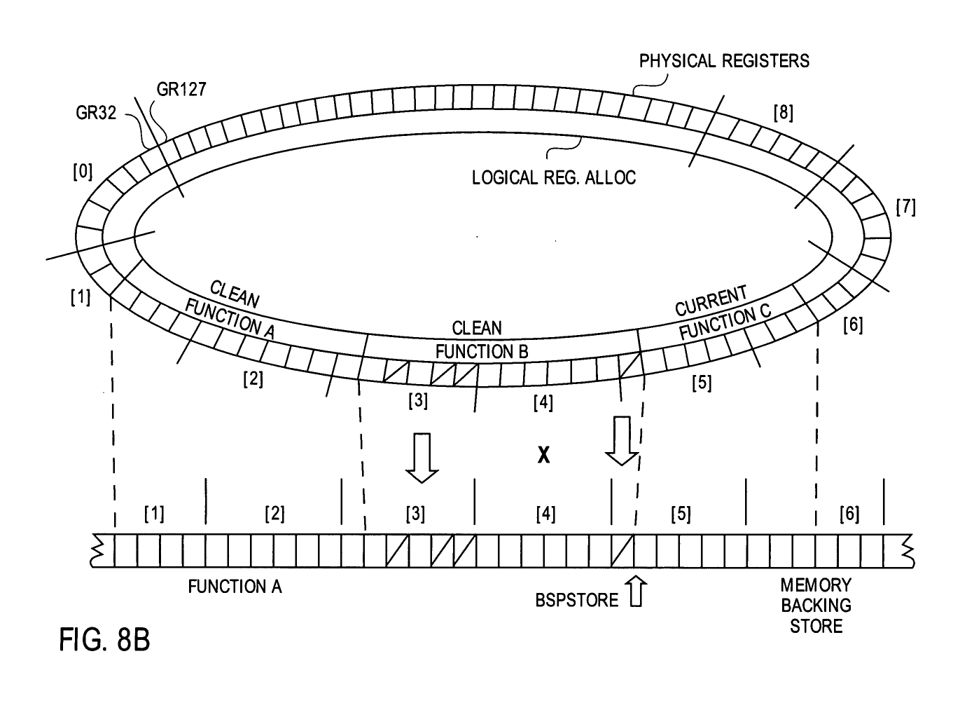

Referring now to FIGS. 8A and 8B, diagrams of the storing of selected sets of registers identified by the rMask bits are shown, according to an embodiment of the present disclosure. FIG. 8A generally shows the registers allocated to function B before spilling the register contents to memory backing store, whereas FIG. 8B generally shows the registers allocated to function B after spilling with the selected register contents in memory backing store. The 96 general registers from Gr32 through Gr127 are shown subdivided into 12 subsets numbered [0] through [11] in the drawing. For the sake of example, let the registers allocated to function B go from GrA, within subset [3], through GrB, within subset [5]. During the current execution of function B, let registers within subsets [3] and [5] be used by function B. This may cause the RSE to set bits 3 and 5 within the rMask field of FIG. 7B. When function B calls another function C, and the RSE needs to reclaim some registers from those allocated to function B, a spill operation may be initiated. In this case, the non-exclusive boundaries are formed by the boundaries of the subsets containing registers used by function B. In FIG. 8B, only those physical registers within subsets [3] and [5] may be spilled to the memory backing store, as indicated by the arrows in the drawing. There are no physical registers that were used in subset [4], so none of these need be spilled to memory backing store as indicated by the “X” in the drawing. The BSPSTORE pointer ends up in the same position as in the FIGS. 4A and 4B example. This is because the allocation of physical registers to function B has not changed, and the memory backing store may still be tailored to hold all physical registers that have been allocated to the function, regardless of whether they have been used.

The use of the subsets may not appear to be a particularly advantageous embodiment, in that the contents of all of the registers within a subset need to be saved to memory backing store even if only one register within the subset was used by function B. However, this embodiment makes use of the fact that writing back from a cache, or reading into cache from memory, takes place in even units of cache line size. Whether one byte or all of the bytes in a cache line are modified, the entire cache line will be written back to (or loaded from) higher level cache or system memory. A subset size of 8 registers, each of 64 bits, may be a match to a cache line size of 64 bytes. Therefore in the FIGS. 8A and 8B embodiment, each subset [3] and [5] may be evenly written to a corresponding cache line when the transfer is aligned on cache line boundaries. Thus when the portion of the register stack backing store for function B may be evicted from L1 cache to a higher-level cache, or to system memory, it may do so on the basis of relatively few cache lines being transferred. Similarly, when function B is restored, if the corresponding fill operation is a miss on the L1 cache then only relatively few cache lines need be loaded down into the L1 cache. A subsequent fill operation would be able to recover the rMask value and fill only the appropriate registers from the memory backing store, thus restoring the register stack for use by function B. In other embodiments, the architecture may require in certain circumstances that all of the allocated registers of function B be restored from the memory backing store regardless of whether the selective spilling as described above was previously performed. In these embodiments the filling may not be selective and any benefits may be limited to those supplied by the selective spilling as described above.

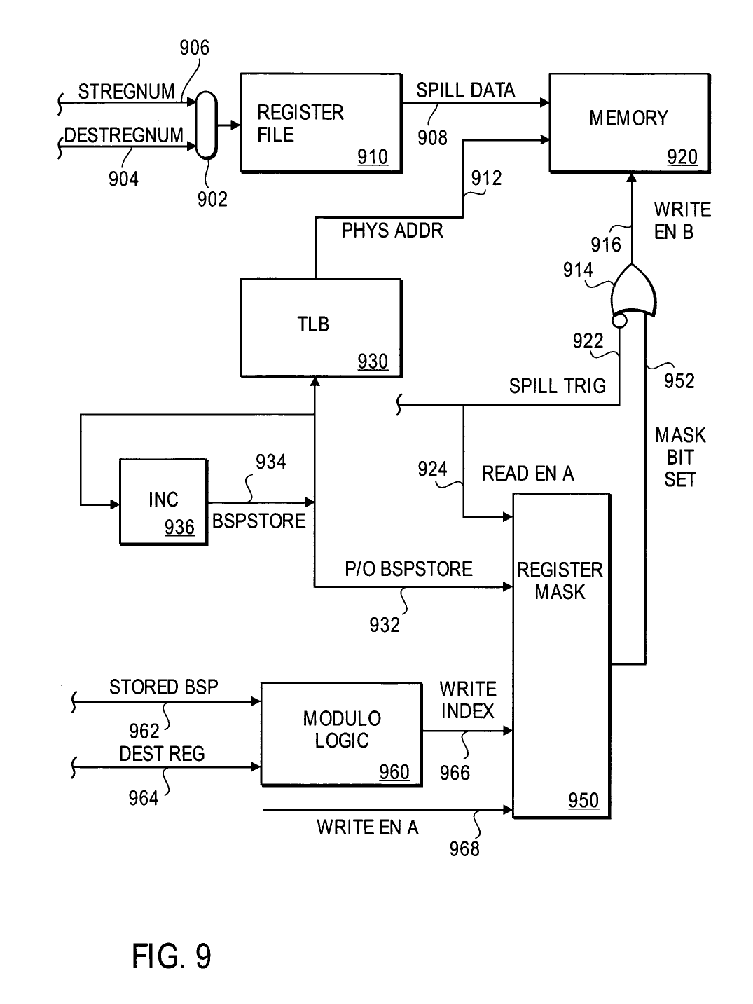

Referring now to FIG. 9, a schematic diagram of circuit elements to produce and use a register mask 950 during register spill is shown, according to an embodiment of the present disclosure. The register mask 950 may be initialized to zeros when the function is first called. The register mask 950 may be written into during normal execution of the function under consideration. A modulo logic 960 performs the modulo arithmetic required by the ring structure of the physical registers allocated to the function. The modulo logic 960 uses the stored backing store pointer (BSP) value 962, corresponding to the base of frame of the function, and the destination register number 964 of an instruction being issued from the processor's issue unit, to produce a write index signal 966 corresponding to which physical register is to be written, and hence have the mask bit set corresponding to the subset that physical register is included within. In one embodiment the modulo logic 960 may calculate the value (BSP+(destination register number−32)<<3) and use bits [9:6] thereof. The mask bit may be set when a write enable A 968 signal permits. This process continues during the execution of the function.

When the current function calls a new function, the register mask 950 will have set all of the bits corresponding to subsets with at least one register being used. When the physical registers of the calling function are spilled memory, an incrementing register 936 may initially contain the initial BSPSTORE pointer value, and may increment the value of BSPSTORE to traverse in turn all the physical registers allocated to the function. The full BSPSTORE pointer may be applied to the translation look-aside buffer (TLB) 930 to supply the physical address 912 to memory 920. Now the register file 910 may be indexed for storing to memory using a DESTREGNUM signal 904 during normal operations and using a STREGNUM signal 906 during spill operations supported by the RSE. Logic 902 selects the correct signal. Thus the BSPSTORE pointer 934 and the STREGNUM signal 904 supply the basic indexing to support spilling.

The register mask 950 may be read from using part of the BSPSTORE pointer (in one embodiment bits 6 through 9) and a read enable A signal 924. The read enable A signal 924 may also serve as a spill trigger signal 922. The memory 920 may receive a write enable B signal 916 produced by gate 914 from the spill trigger signal 922 and the mask bit set signal 952. In this manner, the writes to memory may be permitted for physical registers within a subset whose register mask bit is set, and may be inhibited for physical registers within a subset whose register mask bit is clear.

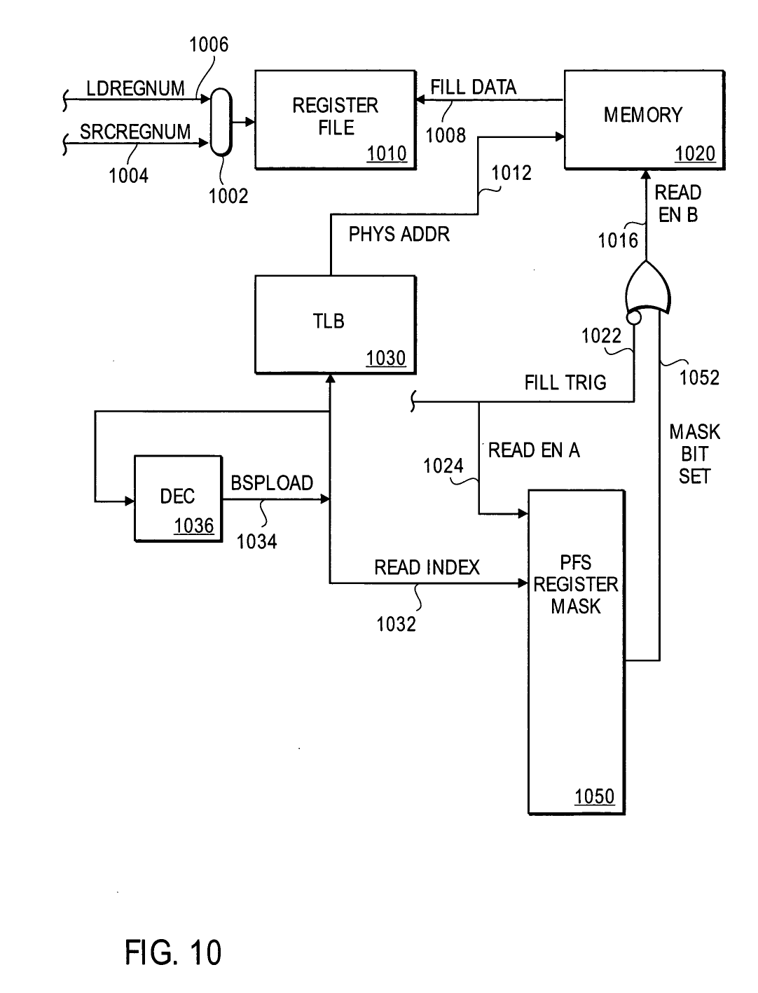

Referring now to FIG. 10, a schematic diagram of circuit elements to recall and use a register mask during register fill is shown, according to an embodiment of the present disclosure. The corresponding register mask from the PFS register is placed into PFS register mask 1050. Generally the spill process of FIG. 9 is reversed. A decrementing register 1036 may initially contain the BSPLOAD pointer value at the top of the returning function's stack, and may decrement the value of BSPLOAD to traverse in turn all the physical registers allocated to the function. The full BSPLOAD pointer may be applied to the translation look-aside buffer (TLB) 1030 to supply the physical address 1012 to memory 1020. The register file 1010 may be indexed for loading from memory using a SRCTREGNUM signal 1004 during normal operations and using a LDREGNUM signal 1006 during fill operations supported by the RSE. Logic 1002 selects the correct signal. Thus the BSPLOAD pointer 1034 and the LDREGNUM signal 1004 supply the basic indexing to support filling.

The PFS register mask 1050 may be read from using part of the BSPLOAD pointer (in one embodiment bits 6 through 9) and a read enable A signal 1024. The read enable A signal 1024 may also serve as a fill trigger signal 1022. The memory 1020 may receive a read enable B signal 1016 produced by gate 1014 from the fill trigger signal 1022 and the mask bit set signal 1052. In this manner, the reads from memory may be permitted for physical registers within a subset whose register mask bit is set, and may be inhibited for physical registers within a subset whose register mask bit is clear. In other embodiments, the architecture may require in certain circumstances that all of the allocated registers of function B be restored from the memory backing store regardless of whether the selective spilling as described above was previously performed, and the use of the FIG. 10 circuits may not accompany the use of the FIG. 9 circuits.

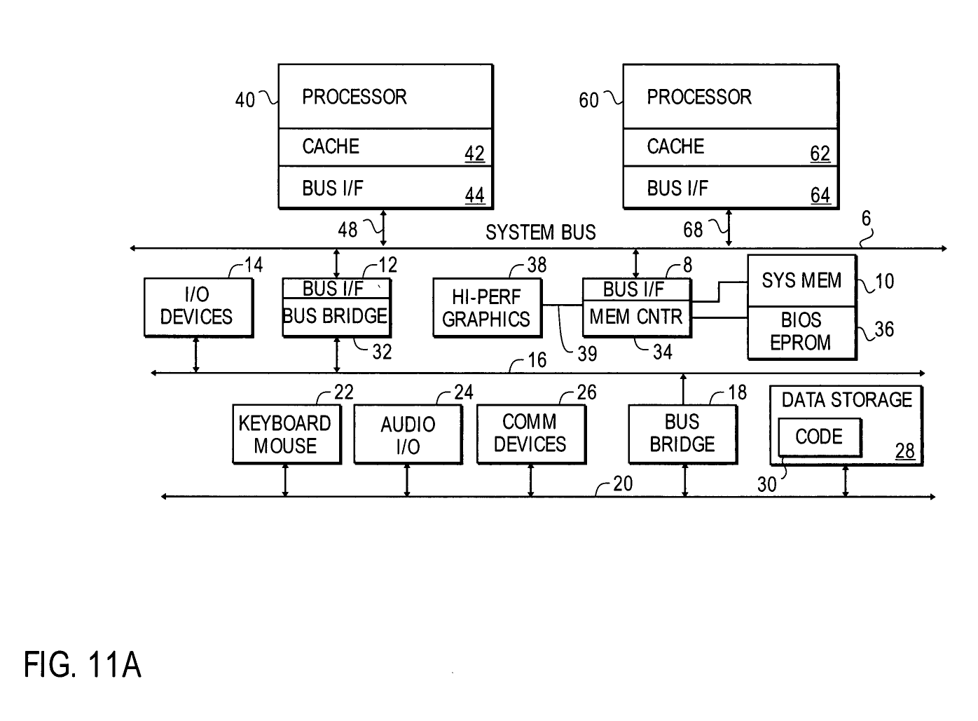

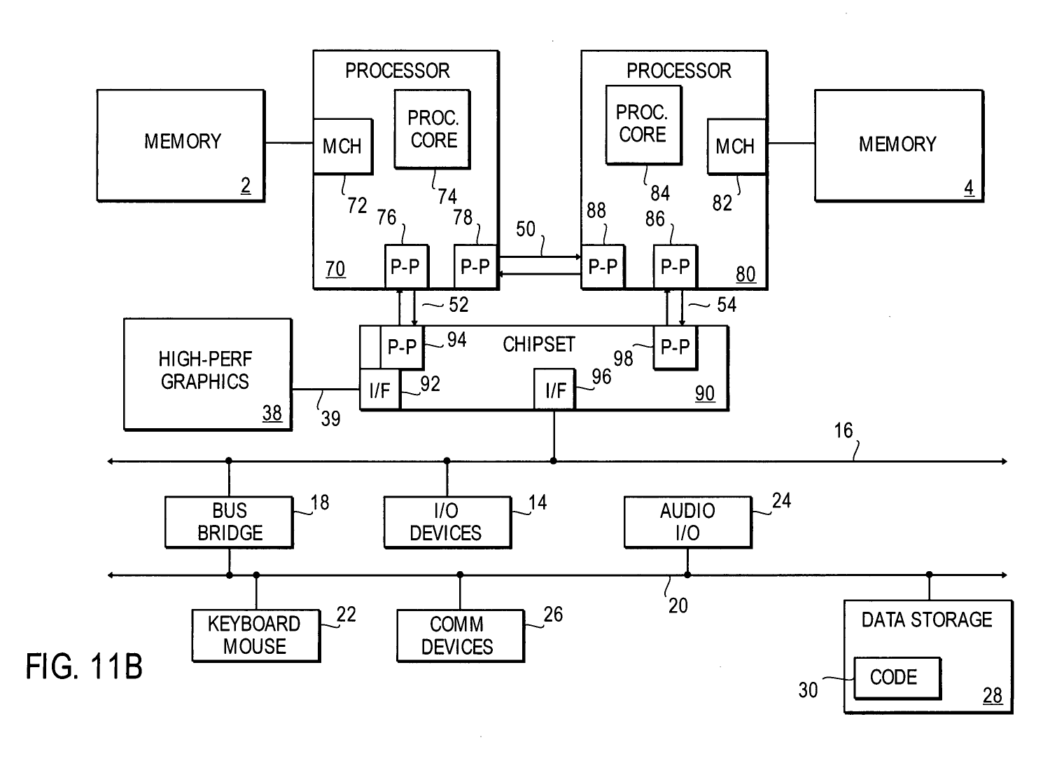

Referring now to FIGS. 11A and 11B, schematic diagrams of systems including a processor supporting selective storing of registers in a register stack backing store are shown, according to two embodiments of the present disclosure. The FIG. 11A system generally shows a system where processors, memory, and input/output devices are interconnected by a system bus, whereas the FIG. 11B system generally shows a system where processors, memory, and input/output devices are interconnected by a number of point-to-point interfaces.

The FIG. 11A system may include several processors, of which only two, processors 40, 60 are shown for clarity. Processors 40, 60 may include level one caches 42, 62. The FIG. 11A system may have several functions connected via bus interfaces 44, 64, 12, 8 with a system bus 6. In one embodiment, system bus 6 may be the Itanium™ system bus utilized with Itanium™ class microprocessors manufactured by Intel® Corporation. In other embodiments, other buses may be used. In some embodiments memory controller 34 and bus bridge 32 may collectively be referred to as a chipset. In some embodiments, functions of a chipset may be divided among physical chips differently than as shown in the FIG. 11A embodiment.

Memory controller 34 may permit processors 40, 60 to read and write from system memory 10 and from a basic input/output system (BIOS) erasable programmable read-only memory (EPROM) 36. In some embodiments BIOS EPROM 36 may utilize flash memory. Memory controller 34 may include a bus interface 8 to permit memory read and write data to be carried to and from bus agents on system bus 6. Memory controller 34 may also connect with a high-performance graphics circuit 38 across a high-performance graphics interface 39. In certain embodiments the high-performance graphics interface 39 may be an advanced graphics port AGP interface. Memory controller 34 may direct read data from system memory 10 to the high-performance graphics circuit 38 across high-performance graphics interface 39.

The FIG. 11B system may also include several processors, of which only two, processors 70, 80 are shown for clarity. Processors 70, 80 may each include a local memory controller hub (MCH) 72, 82 to connect with memory 2, 4. Processors 70, 80 may exchange data via a point-to-point interface 50 using point-to-point interface circuits 78, 88. Processors 70, 80 may each exchange data with a chipset 90 via individual point-to-point interfaces 52, 54 using point to point interface circuits 76, 94, 86, 98. Chipset 90 may also exchange data with a high-performance graphics circuit 38 via a high-performance graphics interface 92.

In the FIG. 11A system, bus bridge 32 may permit data exchanges between system bus 6 and bus 16, which may in some embodiments be a industry standard architecture (ISA) bus or a peripheral component interconnect (PCI) bus. In the FIG. 11B system, chipset 90 may exchange data with a bus 16 via a bus interface 96. In either system, there may be various input/output I/O devices 14 on the bus 16, including in some embodiments low performance graphics controllers, video controllers, and networking controllers. Another bus bridge 18 may in some embodiments be used to permit data exchanges between bus 16 and bus 20. Bus 20 may in some embodiments be a small computer system interface (SCSI) bus, an integrated drive electronics (IDE) bus, or a universal serial bus (USB) bus. Additional I/O devices may be connected with bus 20. These may include keyboard and cursor control devices 22, including mice, audio I/O 24, communications devices 26, including modems and network interfaces, and data storage devices 28. Software code 30 may be stored on data storage device 28. In some embodiments, data storage device 28 may be a fixed magnetic disk, a floppy disk drive, an optical disk drive, a magneto-optical disk drive, a magnetic tape, or non-volatile memory including flash memory.

In the foregoing specification, the invention has been described with reference to specific exemplary embodiments thereof. It will, however, be evident that various modifications and changes may be made thereto without departing from the broader spirit and scope of the invention as set forth in the appended claims. In particular, the selection of the non-exclusive boundaries for the selective storing of the register stack into the register stack backing store may be accomplished in many ways. The specification and drawings are, accordingly, to be regarded in an illustrative rather than a restrictive sense.

1. A processor, comprising:
a first set of registers allocated to a first function; and
a circuit to selectively store contents of a first subset of said first set of registers to a memory upon making current a second function, wherein said first set of registers is not re-allocated.

2. The processor of claim 1, wherein said circuit to restore said contents to said first set of registers when said first function becomes current again.

3. The processor of claim 1, wherein said circuit determines non-exclusive boundaries of said first subset responsive to which registers of said first set of registers were accessed by said first function before said second function was made current.

4. The processor of claim 3, wherein said boundaries include a greatest register seen.

5. The processor of claim 4, wherein said greatest register seen value is initialized to zero when said first function is called.

6. The processor of claim 3, wherein said boundaries include M subsets including subdivisions of said first set of registers.

7. The processor of claim 6, wherein said circuit includes a set of M bits, wherein one of said M bits is set when said first function accesses one of said first set of registers contained in a corresponding one of said M subsets.

8. The processor of claim 7, wherein said one of said M bits is initialized to zero when said first function is called.

9. The processor of claim 7, wherein said circuit uses said set of M bits to restore said contents to said first set of registers when said first function becomes current again.

10. The processor of claim 7, wherein a first number of bytes of one of said M subsets corresponds to a second number of bytes of a cache line of said memory.

11. A method, comprising:
allocating a first set of registers for a first function;
determining a first subset of said first set of registers whose contents permit the restoration of state for said first function; and
storing said contents of said subset in a memory.

12. The method of claim 11, wherein said determining includes recording whether one of said set of registers has been accessed by said first function before a second function becomes current.

13. The method of claim 12, wherein said recording produces a greatest register seen.

14. The method of claim 13, wherein said greatest register seen may form a boundary of said first subset.

15. The method of claim 12, further comprising dividing said first set of registers into M subsets.

16. The method of claim 15, wherein said recording includes setting a bit corresponding to one of said subsets that contains said one of said first set of registers.

17. The method of claim 15, wherein said subsets correspond in number of bytes to a cache line of said memory.

18. A system, comprising:
a processor including a first set of registers allocated to a first function, and a circuit to selectively store contents of a first subset of said first set of registers to a memory upon making current a second function, wherein said first set of registers is not re-allocated;
an interconnect to couple said processor to input/output devices; and
an audio input/output device coupled to said interconnect and to said processor.

19. The system of claim 18, wherein said circuit to restore said contents to said first set of registers when said first function becomes current again.

20. The system of claim 18, wherein said circuit determines non-exclusive boundaries of said first subset responsive to which registers of said first set of registers were accessed by said first function before said second function was made current.

21. The system of claim 20, wherein said boundaries include a greatest register seen.

22. The system of claim 20, wherein said boundaries include M subsets including subdivisions of said first set of registers.

23. The system of claim 22, wherein said circuit includes a set of M bits, wherein one of said M bits is set when said first function accesses one of said first set of registers contained in a corresponding one of said M subsets.

24. The system of claim 23, wherein said circuit uses said set of M bits to restore said contents to said first set of registers when said first function becomes current again.

25. The system of claim 24, wherein a first number of bytes of one of said M subsets corresponds to a second number of bytes of a cache line of said memory.

26. A processor, comprising:
means for allocating a first set of registers for a first function;
means for determining a first subset of said first set of registers whose contents permit the restoration of state for said first function; and
means for storing said contents of said subset in a memory.

27. The processor of claim 26, wherein said means for determining includes means for recording whether one of said set of registers has been accessed by said first function before a second function becomes current.

28. The processor of claim 27, wherein said means for recording produces a greatest register seen.

29. The processor of claim 28, wherein said greatest register seen may form a boundary of said first subset.

30. The processor of claim 27, further comprising means for dividing said first set of registers into M subsets.

31. The processor of claim 30, wherein said means for recording includes means for setting a bit corresponding to one of said subsets that contains said one of said first set of registers.

32. The processor of claim 30, wherein said subsets correspond in number of bytes to a cache line of said memory.
